(19) United States
(12) Patent Application Publication
(10) Pub. No.: US 2007/0024429 A1
(43) Pub. Date: Feb. 1, 2007

(54) APPARATUS AND METHOD FOR INFORMING VEHICULAR SAFETY DISTANCE

(76) Inventor: Kyeong Sub SONG, Icheon-shi (KR)

Correspondence Address: IPLA P.A., 3580 WILSHIRE BLVD., 17TH FLOOR, LOS ANGELES, CA, 90010, US

(21) Appl. No.: 11/424,856

(22) Filed: Jun. 17, 2006

(30) Foreign Application Priority Data
Jul. 27, 2005 (KR) 10-2005-0068282

(51) Int. Cl. B60Q 1/00

(52) U.S. Cl. 340/435

(57) ABSTRACT

An apparatus and method for informing a vehicular safety distance is provided. The apparatus includes a first camera for photographing the front of a vehicle; a first distance measuring unit for measuring a distance from a front vehicle; a second camera for photographing the rear of the vehicle; a second distance measuring unit for measuring a distance from a rear vehicle; a storage unit for storing a lane pattern and reference patterns for the front and rear of the vehicle for detecting whether or not there exist the front and rear vehicles in photographed images; and a controller for comparing the photographed images with the front and rear reference patterns to detect the front and rear vehicles, detecting a lane of the detected vehicle, and controlling the first and second distance measuring unit to measure the distances.

### BACKGROUND OF THE INVENTION

1. Field of the Invention

The present invention relates to a vehicular safety system, and more particularly, to an apparatus and method for informing a vehicular safety distance, for determining whether or not front/rear objects are vehicles, determining driving lanes of the front/rear vehicles, and displaying distances from the front/rear vehicles.

2. Description of the Related Art

Owing to rapid developments of a motor industry and an electronic industry, a car is equipped with the latest electronic devices, thereby being most advanced. One of the most advanced car technologies is a safety system for preventing a variety of traffic accidents. As such safety systems, there are an anti-collision system for preventing collision with an object including the car or a pedestrian, an airbag system for protecting a driver in collision, and an anti-theft system for preventing car theft.

As the anti-collision system among them, there is a rear alerting device for determining whether or not there exists an object in rear and, when there exists the rear object, measuring and displaying a distance between the rear object and a vehicle for the driver, and an anti-collision device for measuring a distance from a front vehicle and, when the front vehicle is closer below a reference distance, decelerating the vehicle.

However, the rear alerting device and the anti-collision device measure the distance from the object using a distance measurement sensor and, on the basis of the measured distance, generate an alert and reduce a speed. Therefore, it is difficult to detect the object at an area where a road has many curves. As it is difficult to detect the object, there is a drawback of being incapable of measuring the distance from the object. In order to solve this drawback, devices having cameras installed in front and rear and allowing the driver to perform direct check with his/her naked eyes are being developed and sold. However, even in these devices, when the driver dozes off while driving, danger can also occur in detecting the object and measuring the distance using the distance measurement sensor.

Further, the rear alerting device can detect the rear object only when the vehicle goes back. Therefore, there is a drawback of, when the vehicle changes the lane while driven to the front, being incapable of measuring the distance from the rear object.

### SUMMARY OF THE INVENTION

Accordingly, the present invention is directed to an apparatus and method for informing a vehicular safety distance that substantially overcomes one or more of the limitations and disadvantages of the conventional art.

One object of the present invention is to provide an apparatus and method for informing a vehicular safety distance, for determining whether or not front/rear objects are vehicles, determining driving lanes of the front/rear vehicles, and displaying distances from the front/rear vehicles.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an apparatus for informing a vehicular safety distance, the apparatus including: a first camera for photographing the front of a vehicle; a first distance measuring unit for measuring a distance from a front vehicle under a predetermined control; a second camera for photographing the rear of the vehicle; a second distance measuring unit for measuring a distance from a rear vehicle under a predetermined control; a storage unit for storing a lane pattern and reference patterns for the front and rear of the vehicle for detecting whether or not there exist the front and rear vehicles in images photographed through the first and second cameras; and a controller for comparing the photographed images with the front and rear reference patterns to detect the front and rear vehicles, detecting a lane of the detected vehicle, and controlling the first and second distance measuring unit to measure the distances.

In another aspect of the present invention, there is provided an apparatus for informing a vehicular safety distance, the apparatus including: a front vehicle detector for detecting a front driving vehicle and a driving lane of the vehicle, measuring a distance from the detected vehicle, and outputting lane information and the measured distance for the detected vehicle; a rear vehicle detector for detecting a rear driving vehicle and a driving lane of the vehicle, measuring a distance from the detected vehicle, and outputting lane information and the measured distance for the detected vehicle; a display unit for receiving and displaying the lane information and the measured distances for the detected front and rear vehicles; and a controller for receiving the lane information and the measured distances for the detected vehicles from the respective front and rear vehicle detectors, and controlling the display unit to display the received lane information and distances.

In a further another aspect of the present invention, there is provided a method for informing a vehicular safety distance in a vehicular safety-distance informative apparatus having at least one camera and distance measuring unit provided at the front and the rear, respectively, and a storage unit for storing a lane pattern and reference patterns for a front portion and a rear portion of a vehicle, the method including: a first step of, upon setting to be in a vehicular safety distance informative mode, enabling the camera and distance measuring unit; a second step of detecting front and rear vehicles; a third step of detecting a driving lane of the detected vehicle; a fourth step of measuring a distance from the detected vehicle; and a fifth step of displaying the measured distance.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of an apparatus for informing a vehicular safety distance according to the first embodiment of the present invention;

FIG. 2 illustrates a construction of an apparatus for informing a vehicular safety distance according to the second embodiment of the present invention;

FIG. 3 is a flowchart illustrating a method for informing a vehicular safety distance according to the present invention;

FIG. 4 is a flowchart illustrating a method for detecting front/rear vehicles of FIG. 3;

FIG. 5 is a flowchart illustrating a method for detecting a lane of FIG. 3;

FIG. 6 is an example of measuring distances from front/rear vehicles according to the present invention;

FIG. 7 is another example of measuring distances from front/rear vehicles according to the present invention;

FIG. 8 illustrates a vehicle reference pattern for detecting front/rear vehicles according to the present invention; and

FIG. 9 is an example of displaying distance from front/rear vehicles according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention provides a method for photographing the front and the rear of a self vehicle, comparing images of the photographed front and rear with previously stored patterns of vehicular front and rear portions to detect a vehicle, determining whether the detected vehicle is on a driving lane of the self vehicle or on other lanes, measuring a distance from the detected vehicle when the detected vehicle is determined to be on the same lane, and displaying the measured distance for a driver.

Further, in the present invention, a camera and a distance measuring unit are integrated as one unit, the unit is provided three by three in each of front and rear of the self vehicle, a central unit measures a distance on the driving lane of the self vehicle, and both-sided units detect the vehicles on both lanes centering on the driving lane of the self vehicle and measure the distances from the detected vehicles.

Furthermore, the present invention includes a display unit provided at a room mirror or a side mirror, and displaying the measured distance together with lane information.

Hereinafter, a construction and an operation of the apparatus for informing the safety distance according to the present invention will be described with reference to the drawings.

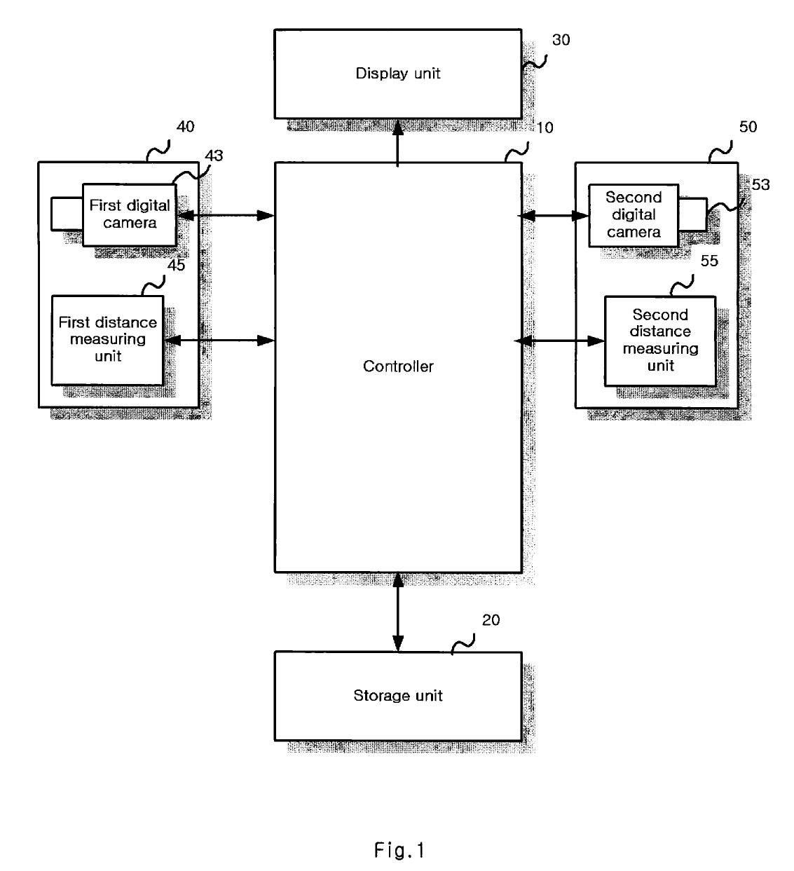

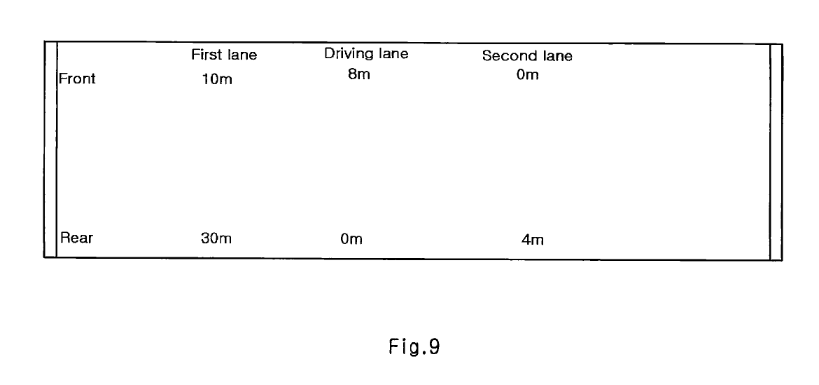

FIG. 1 illustrates a construction of an apparatus for informing a vehicular safety distance according to the first embodiment of the present invention, and FIG. 9 is an example of displaying distances from the front/rear vehicles according to the present invention.

Referring to FIGS. 1 and 9, the inventive apparatus for informing the vehicular safety distance includes a controller 10; a storage unit 20; the display unit 30; a front unit 40 comprised of a first digital camera 43 and a first distance measuring unit 45; and a rear unit 50 comprised of a second digital camera 53 and a second distance measuring unit 55. The front unit 40 and the rear unit 50 are each provided three by three, but it should be noted that, since they perform the same construction and the same operation, only one unit will be described for the respective construction and operation.

The controller 10 controls a general operation of the apparatus for informing the vehicular safety distance.

The storage unit 20 includes a region for storing a control program for controlling the operation of the inventive apparatus; a region for temporarily storing data generated in execution of the control program; and a region for storing the patterns of the vehicular front and rear portions and a lane pattern.

As shown in FIG. 9, the display unit 30 displays whether or not the vehicle is detected on front and rear lanes and a distance from the detected vehicle under the control of the controller 10. As shown in FIG. 9, the display unit 30 can be provided at the room mirror of the self vehicle, and can be also provided even at the side mirror in the same type. The display unit 30 can also provide a graphic display using a display device such as a general graphic liquid crystal display.

The front unit 40 includes the first digital camera 43 for photographing the front, and the first distance measuring unit 45 for measuring the distance from the vehicle detected using the first digital camera 43.

The rear unit 50 includes the second digital camera 53 for photographing the rear, and the second distance measuring unit 45 for measuring the distance from the vehicle detected using the second digital camera 53.

An operation of the controller 10 according to the present invention will be in detail described. The controller 10 compares the images photographed through the first and second cameras with the front and rear reference patterns of the respective first and second cameras, detects the front and rear vehicles, detects the lanes of the detected vehicles, controls the first and second distance measuring units to measure the distances from the detected vehicles, and displays the measured distances on the display unit 30.

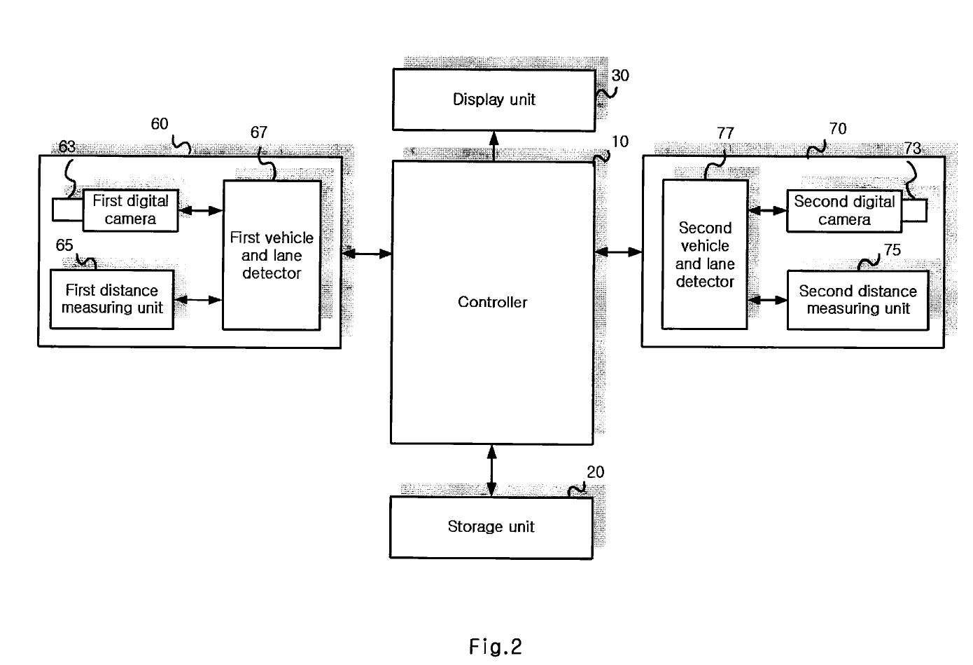

FIG. 2 illustrates a construction of the apparatus for informing the vehicular safety distance according to the second embodiment of the present invention.

Referring below to FIG. 2, the inventive apparatus for informing the vehicular safety distance includes a controller 10, a storage unit 20, a display unit 30, a front vehicle detector 60, and a rear vehicle detector 70.

In the second embodiment of the present invention, in order to reduce an operation load of the controller 10 of FIG. 1, the front and rear vehicle detectors 60 and 70 perform control operations of detecting the front/rear vehicles, detecting the lane, and measuring the distances from the detected vehicles. The controller 10 receives the distances from the detected vehicles from the front and rear vehicle detectors 60 and 70, and displays the received distances on the display unit 30.

The front vehicle detector 60 includes a first digital camera 63 for photographing the front; a first distance measuring unit 65 for measuring the distance from the vehicle detected using the first digital camera 63; and a first vehicle and lane detector 67 for storing patterns of vehicular front and rear portions and a lane pattern, comparing an image photographed in the first digital camera 63 with the pattern of the vehicular front portion to detect the vehicle, comparing the lane with the lane pattern to recognize the lane, and controlling the first distance measuring unit 65 to measure the distance from the detected vehicle and output the measured distance to the controller 10.

The rear vehicle detector 70 includes a second digital camera 73 for photographing the rear; a second distance measuring unit 75 for measuring the distance from the vehicle detected using the second digital camera 73; and a second vehicle and lane detector 77 for storing the patterns of the vehicular front and rear portions and the lane pattern, comparing the image photographed in the second digital camera 73 with the pattern of the vehicular rear portion to detect the vehicle, comparing the lane with the lane pattern to recognize the lane, and controlling the second distance measuring unit 75 to measure the distance from the detected vehicle and output the measured distance to the controller 10.

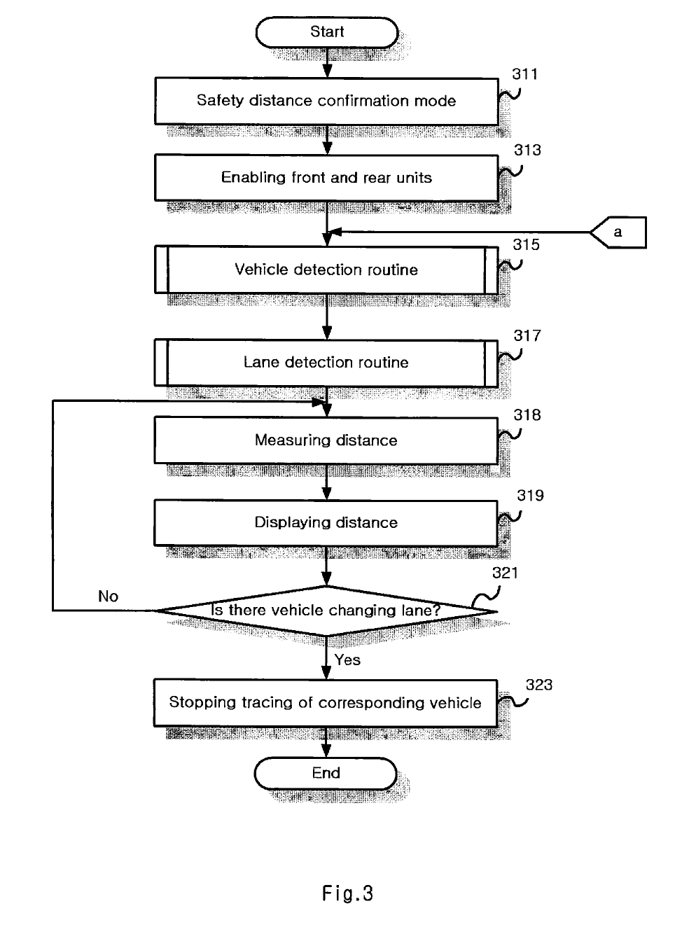

FIG. 3 is a flowchart illustrating a method for informing the vehicular safety distance according to the present invention. A description will be made with reference to FIGS. 1 and 3.

First, the controller 10 sets to be in a safety distance informative mode in Step 311. The safety distance informative mode is automatically set when a power source is applied to the safety distance informative apparatus, or is set when a user presses a key on a key input unit (not shown) for executing the safety distance informative mode.

If the vehicular safety distance informative mode is set in the Step 311, the controller 10 enables the front unit 30 and the rear unit 40 in Step 313.

Upon enabling of the front unit 40 and the rear unit 50, in Step 315, the controller 10 performs a routine of detecting the front/rear vehicles. In the detection routine, it is determined whether or not there exists the vehicle in the images photographed through the first and second digital cameras 43 and 53.

Upon detection of the vehicle through the detection routine, in Step 317, the controller 10 performs a routine of detecting the lane. This is performed in the front unit 40 and the rear unit 50 having charge of the respective lanes so as to prevent erroneous measurement at a curve road.

After the execution of the routine of detecting the lane, in Step 318, the controller 10 controls the first and second distance measuring units 45 and 55 for the front and the rear to measure the distances from the detected vehicles and, in Step 319, displays the measured distances on the display unit 30.

Upon measurement of the distances from the detected vehicles, in Step 321, the controller 10 sequentially determines whether or not the detected vehicle changes the lane. If it is determined that the detected vehicle changes the lane in the Step 321, in Step 323, the controller 10 stops tracing of the corresponding detected vehicle and measuring of the distance.

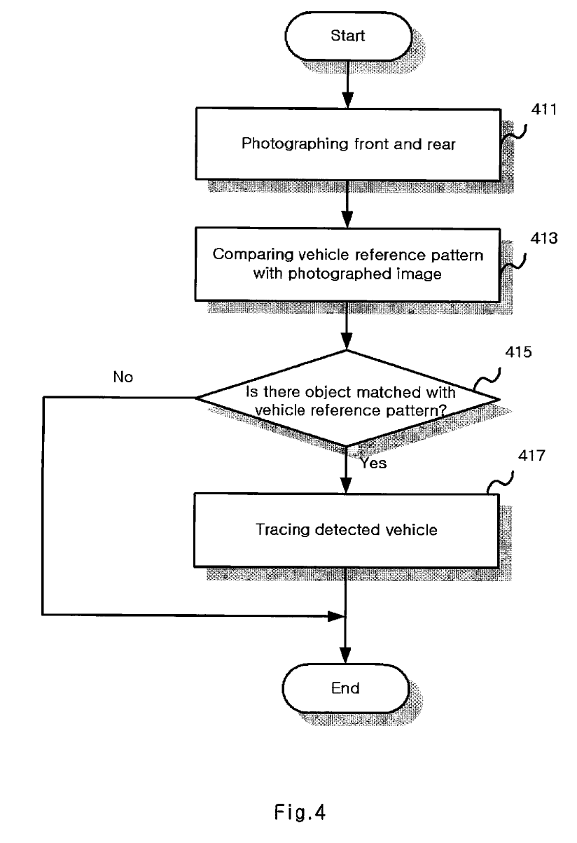

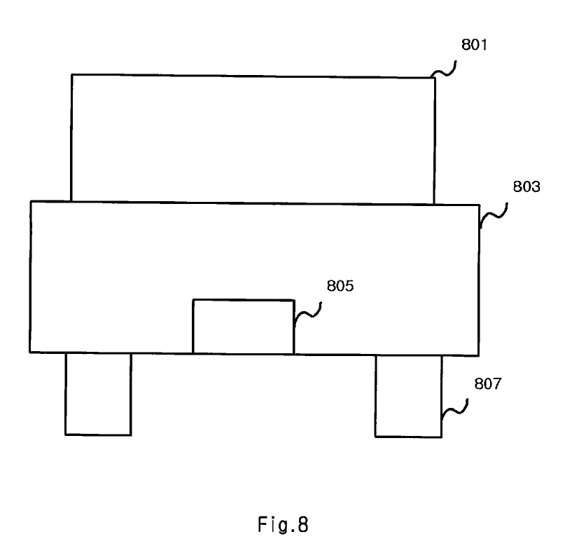

FIG. 4 is a flowchart illustrating a method for detecting the front/rear vehicles of FIG. 3, and FIG. 8 illustrates the vehicle reference pattern for detecting the front/rear vehicles according to the present invention. The vehicle detecting method of the detection routine of FIG. 3 will be described below with reference to FIGS. 1, 3, 4, and 8.

In Step 411, the controller 10 enables the first and second digital cameras 43 and 53, to photograph the front and the rear. Upon initiation of the photographing of the front and the rear, in Step 413, the controller 10 reads the vehicle reference pattern of FIG. 8 stored in the storage unit 20, that is, the pattern of the vehicular front or rear portion and compares the pattern with the photographed image and, in Step 415, determines whether or not the pattern is consistent with the photographed image. Upon detection of the consistent image in the Step 415, in Step 417, the controller 10 traces the detected vehicle. In order to trace the detected vehicle, the digital camera can be constructed to be moveable in hardware, or can be constructed in software. It is desired that, even when the digital camera is enabled in software, the respective distance measurement units are rotatably constructed to more exactly measure the distance.

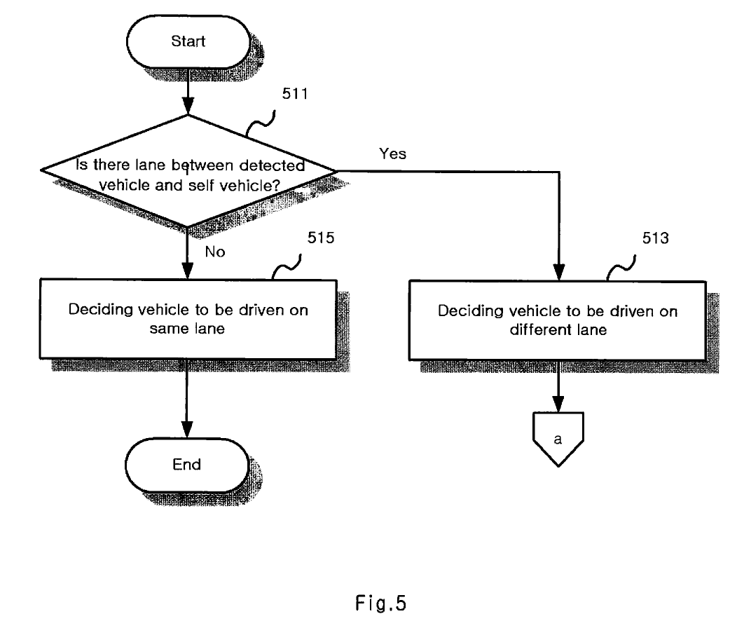

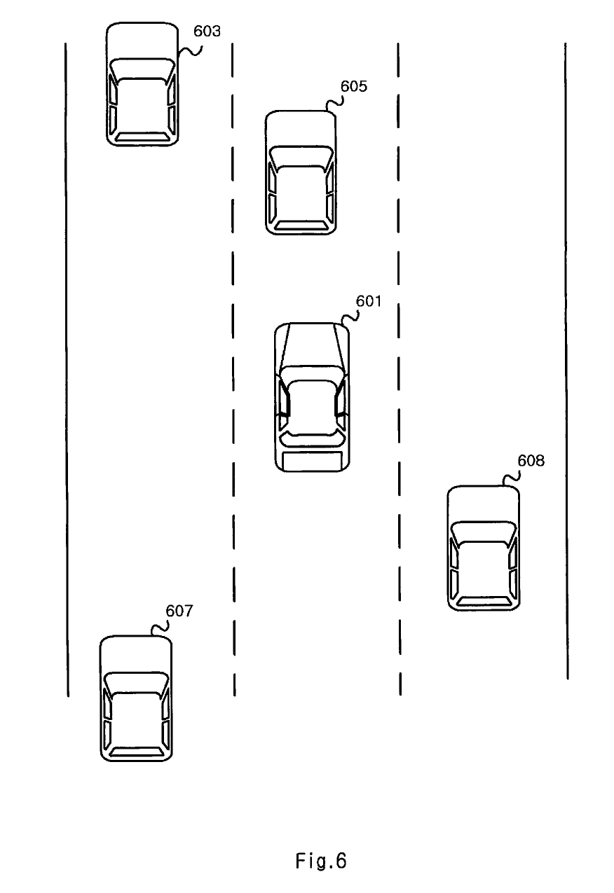

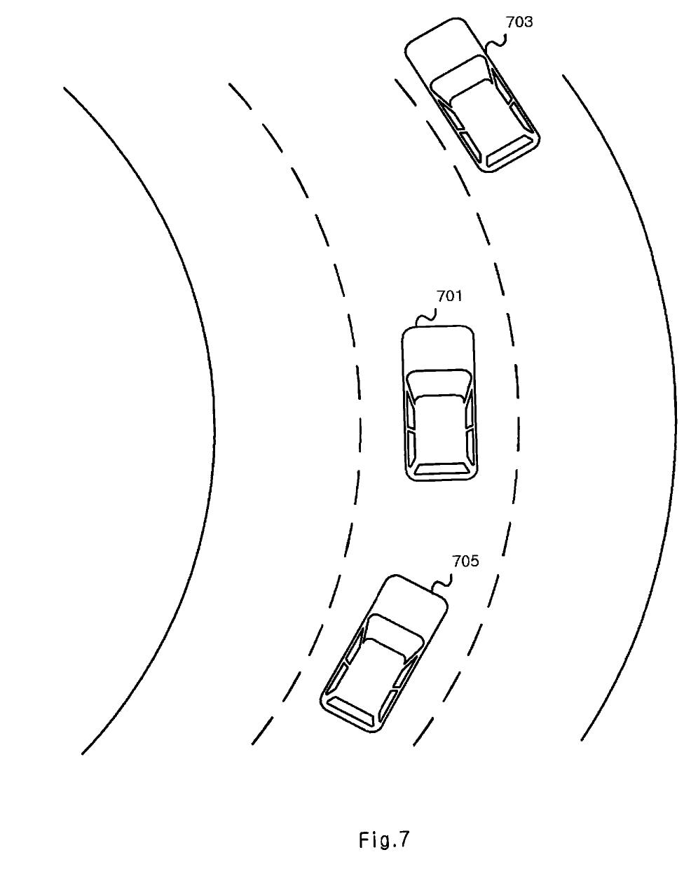

FIG. 5 is a flowchart illustrating a method for detecting the lane of FIG. 3, FIG. 6 is an example of measuring the distances from the front/rear vehicles according to the present invention, and FIG. 7 is another example of measuring the distances from the front/rear vehicles according to the present invention. A description will be made with reference to FIGS. 1 and FIGS. 5 to 6 below.

In Step 511, the controller 10 reads the lane pattern from the storage unit 20, compares the read lane pattern with the photographed image, and determines whether or not there is the lane between the detected vehicle and the self vehicle.

If it is determined that there is the lane between the detected vehicle and the self vehicle in the Step 511, in Step 513, the controller 10 decides the detected vehicle to be driven on a different lane, and proceeds with the Step 315 of FIG. 3.

On the contrary, if it is determined that there is not the lane between the detected vehicle and the self vehicle, in Step 515, the controller 10 decides the detected vehicle to be driven on the same lane, and proceeds with the Step 318.

In the routine of detecting the lane, the central front and rear units 40 and 50 determine whether or not the detected vehicle is driven on the substantially same lane as that of the self vehicle. Further, the right front and rear units 40 and 50 regard a right lane of the substantial driving lane of the self vehicle to be the driving lane of the self vehicle. Furthermore, the left front and rear units 40 and 50 regard a left lane of the substantial driving lane of the self vehicle to be the driving lane of the self vehicle. Accordingly, when the lane is detected, the controller 10 performs the detection routine for the right front and rear units 40 and 50 with disregard to one lane substantially existing on the right, and performs the detection routine for the left front and rear units 40 and 50 with disregard to one lane substantially existing on the left.

The routine of detecting the lane is to reduce an error on the curve road as in FIG. 7. In detail, in FIG. 7 where the self vehicle is denoted by 701 and the front vehicle is denoted by 703, if the lane is not detected, the front vehicle 703 can be erroneously recognized to be driven on the lane where the self vehicle is driven. In order to prevent this error, the lane detection routine is performed in the present invention.

In FIG. 6 showing the vehicles driven on a general straight-line road, in a self vehicle 601, a distance from a front vehicle 603 is displayed on an upper and left side of the room mirror of FIG. 9, a distance from another front vehicle 605 is displayed on a center of the room mirror, and a distance of zero meter is displayed since there is not the vehicle on the right lane. As shown in FIG. 9, distances from rear vehicles are displayed on a lower side of the room mirror.

As described above, the present invention has an advantage in that it is detected through the camera whether or not the object is the vehicle, and it is determined whether or not the detected vehicle is driven on the same lane, thereby measuring the distance from the detected vehicle and therefore, the driver can be provided with more exact information.

Further, the present invention has an advantage in that the more exact information can be provided for the front/rear vehicles and applied to a conventional anti-collision system, thereby providing a greater stability.

Furthermore, the present invention has an advantage in that the driver can recognize the accurate distance from the rear vehicle driven on a target lane to be changed, thereby being capable of changing the lane into the target lane with more convenience and safety. In other words, the present invention has an advantage of solving a drawback of being difficult to recognize the substantial distance from the rear vehicle when the driver sees a rear-view mirror while changing the lane.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An apparatus for informing a vehicular safety distance, the apparatus comprising:
a first camera for photographing the front of a vehicle;
a first distance measuring unit for measuring a distance from a front vehicle under a predetermined control;
a second camera for photographing the rear of the vehicle;
a second distance measuring unit for measuring a distance from a rear vehicle under a predetermined control;
a storage unit for storing a lane pattern and reference patterns for the front and rear of the vehicle for detecting whether or not there exist the front and rear vehicles in images photographed through the first and second cameras; and
a controller for comparing the photographed images with the front and rear reference patterns to detect the front and rear vehicles, detecting a lane of the detected vehicle, and controlling the first and second distance measuring unit to measure the distances.

2. The apparatus according to claim 1, wherein the first camera is integrated with the first distance measuring unit, and the second camera is integrated with the second distance measuring unit.

3. The apparatus according to claim 2, wherein the integrated first camera and first distance measuring unit is provided three by three to detect a driving lane and the front vehicles on both-sided lanes of the driving lane.

4. The apparatus according to claim 3, wherein, upon detection of the vehicle and detection of the lane, the controller controls the camera and the distance measuring unit corresponding to the driving lane of the detected vehicle to trace the detected vehicle.

5. The apparatus according to claim 4, wherein the controller stops tracing when the traced vehicle is changed to be on another lane.

6. The apparatus according to claim 3, wherein the integrated second camera and second distance measuring unit is provided three by three to detect the driving lane and the rear vehicles on the both-sided lanes of the driving lane.

7. The apparatus according to claim 6, wherein, upon detection of the vehicle and detection of the lane, the controller controls the camera and the distance measuring unit corresponding to the driving lane of the detected vehicle to trace the detected vehicle.

8. The apparatus according to claim 7, wherein the controller stops tracing when the traced vehicle is changed to be on another lane.

9. The apparatus according to claim 6, further comprising a display unit for displaying distances from the detected front and rear vehicles at each lane.

10. The apparatus according to claim 9, wherein the display unit is provided at a room mirror.

11. The apparatus according to claim 9, wherein the display unit is provided at a side mirror.

12. An apparatus for informing a vehicular safety distance, the apparatus comprising:
a front vehicle detector for detecting a front driving vehicle and a driving lane of the vehicle, measuring a distance from the detected vehicle, and outputting lane information and the measured distance for the detected vehicle;
a rear vehicle detector for detecting a rear driving vehicle and a driving lane of the vehicle, measuring a distance from the detected vehicle, and outputting lane information and the measured distance for the detected vehicle;
a display unit for receiving and displaying the lane information and the measured distances for the detected front and rear vehicles; and
a controller for receiving the lane information and the measured distances for the detected vehicles from the respective front and rear vehicle detectors, and controlling the display unit to display the received lane information and distances.

13. The apparatus according to claim 12, wherein the front and rear vehicle detectors are each provided three by three to detect a driving lane and the front vehicles on both-sided lanes of the driving lane.

14. The apparatus according to claim 12, wherein the front or rear vehicle detector comprises:
a camera for photographing the front or rear of a vehicle;
a distance measuring unit for measuring a distance from a front or rear vehicle under a predetermined control; and
a vehicle and lane detector for storing a lane pattern and reference patterns for a front portion and a rear portion of the vehicle, comparing an image photographed through the camera with the front or rear reference pattern to detect the front or rear vehicle, detecting a lane of the detected vehicle, and controlling the distance measuring unit to measure the distance.

15. The apparatus according to claim 13, wherein the front or rear vehicle detector comprises:
a camera for photographing the front or rear of a vehicle;
a distance measuring unit for measuring a distance from a front or rear vehicle under a predetermined control; and
a vehicle and lane detector for storing a lane pattern and reference patterns for a front portion and a rear portion of the vehicle, comparing an image photographed through the camera with the front or rear reference pattern to detect the front or rear vehicle, detecting a lane of the detected vehicle, and controlling the distance measuring unit to measure the distance.

16. A method for informing a vehicular safety distance in a vehicular safety-distance informative apparatus having at least one camera and distance measuring unit provided at the front and the rear, respectively, and a storage unit for storing a lane pattern and reference patterns for a front portion and a rear portion of a vehicle, the method comprising:
a first step of, upon setting to be in a vehicular safety distance informative mode, enabling the camera and distance measuring unit;
a second step of detecting front and rear vehicles;
a third step of detecting a driving lane of the detected vehicle;
a fourth step of measuring a distance from the detected vehicle; and
a fifth step of displaying the measured distance.

17. The method according to claim 16, wherein the second step comprises the steps of:
photographing the front and the rear through the cameras;
comparing images of the photographed front and rear with the reference patterns to detect the vehicle; and
continuously tracing the detected vehicle.

18. The method according to claim 17, wherein the third step comprises the steps of:
comparing the photographed image with the lane pattern, and determining whether or not there is a lane between the detected vehicle and a self vehicle; and
if the lane is determined to be between the detected vehicle and the self vehicle, returning to the second step and, otherwise, determining that the detected vehicle and the self vehicle are driven on the same lane and proceeding with the fourth step.

19. The method according to claim 18, further comprising:
a sixth step of displaying the distances from the front and rear vehicles, and determining whether or not the front or rear vehicle changes the lane; and
a seventh step of, when the front or rear vehicle changes the lane, stopping tracing of the corresponding vehicle.
